(19) United States
(12) Patent Application Publication
(10) Pub. No.: US 2017/0227500 A1
(43) Pub. Date: Aug. 10, 2017

(54) FITTED COAXIAL WAVEGUIDE SYSTEM FOR GUIDED WAVE INSPECTION OF TUBING

(71) Applicant: FBS, Inc., Bellefonte, PA (US)

(72) Inventors: Cody Borigo, Pennsylvania Furnace, PA (US); Steven E. Owens, Bellefonte, PA (US); Joseph L. Rose, State College, PA (US)

(73) Assignee: FBS, Inc., Bellefonte, PA (US)

(21) Appl. No.: 15/427,647

(22) Filed: Feb. 8, 2017

Related U.S. Application Data
(60) Provisional application No. 62/292,606, filed on Feb. 8, 2016.

(51) Int. Cl. G01N 29/11; G01N 29/24; G01N 29/28; G01N 29/22

(52) U.S. Cl. CPC G01N 29/11; G01N 29/221; G01N 29/2462; G01N 29/28; G01N 2291/2634

(57) ABSTRACT

A system for the non-destructive inspection of a structure includes a probe including a hollow cylindrical waveguide having a first region and a second region. The first region has a first diameter and the second region has a second diameter. The second diameter is greater than the first diameter. The first diameter is sized and configured for insertion into a structure. The system further includes at least one of sensor element capable of generating and detecting longitudinal and/or torsional ultrasonic guided waves in the waveguide. The at least one sensor element is configured to generate a guided wave pulse in the waveguide when a time-varying current is provided to the at least one sensor element. The at least one sensor element is configured to deflect reflected guided wave energy from one or more anomalies in the structure.

### CROSS-REFERENCE TO RELATED APPLICATION

This application claims priority to U.S. Provisional Patent Application No. 62/292,606, filed on Feb. 8, 2016, and entitled “FITTED COAXIAL WAVEGUIDE SYSTEM FOR GUIDED WAVE INSPECTION OF TUBING,” which is incorporated by reference herein in its entirety.

### FIELD

This disclosure relates to the non-destructive inspection of tubing in heat exchangers, boiler tubes, and other similar applications.

### BACKGROUND INFORMATION

Shell and tube style heat exchangers are utilized in the petroleum, nuclear, power generation, and chemical processing industries for a variety of applications. Shell and tube heat exchangers are the most common type found in industry due to their design flexibility and their ability to operate under higher temperatures and pressures than other types of heat exchangers. In most applications it is important that no direct fluid exchange can occur across the tube walls within the exchanger. This is of particular importance in the nuclear energy industry in which fluid on one side of the tube may be radioactively contaminated. This strict separation of fluids can be compromised by tube failure, which is often caused by corrosion, metal erosion, or cracking. Tube failure is additionally problematic because it reduces the thermal efficiency of the system and can impede fluid flow. Therefore regular tube inspection and maintenance is an industry standard.

Several techniques exist for inspecting straight and twisted tubing, including eddy current, IRIS scanning, longitudinal guided waves, and torsional guided waves. However, each of these technique has deficiencies. For instance, the most commonly-employed methods for straight tube inspection, eddy current and IRIS scanning, are often time-consuming and require the probe to be inserted through the entire length of the tube under inspection. Guided wave methods do not require the tool to be inserted through the entire length of the tube, but they require a guided wave to be transmitted through a waveguide and an expansion mechanism, by which the guided wave energy is coupled to the inner tube wall; this expansion mechanism often introduces undesirable noise into the system.

### SUMMARY

In some embodiments, a system for the non-destructive inspection of a structure is disclosed. The system includes a probe including a hollow cylindrical waveguide having a first region and a second region. The first region has a first diameter and the second region has a second diameter. The second diameter is greater than the first diameter. The first diameter is sized and configured for insertion into a structure. The system further includes at least one of sensor element capable of generating and detecting longitudinal and/or torsional ultrasonic guided waves in the waveguide. The at least one sensor element is configured to generate a guided wave pulse in the waveguide when a time-varying current is provided to the at least one sensor element. The at least one sensor element is configured to deflect reflected guided wave energy from one or more anomalies in the structure.

In some embodiments, a method of inspecting a structure is disclosed. The method includes generating guided waves in a structure, wherein the guided waves are generated by at least one sensor element in a waveguide having a first region and a second region. The first region has a first diameter and the second region has a second diameter. The second diameter is greater than the first diameter. The first diameter is sized and configured for insertion into a structure. Reflected guided wave energy is detected from anomalies in the structure. The reflected guided wave energy is detected by the at least one sensor element.

### BRIEF DESCRIPTION OF THE DRAWINGS

FIG. 1 is a conceptual illustration of the difference between ultrasonic bulk waves and ultrasonic guided waves.

FIG. 2 is a drawing of the coordinate system for guided waves in pipes and tubes.

FIG. 3 is a conceptual illustration of the difference between longitudinal and torsional guided waves in pipes and tubes.

FIG. 4 is a drawing of one embodiment of the invention.

FIG. 5A is a drawing of a flexible printed circuit board magnetostrictive sensing coil.

FIG. 5B is a cross-sectional drawing of one magnetostrictive sensor with permanent biasing magnets and another magnetostrictive sensor with a pulsed biasing electromagnet.

FIG. 6 is a cross-sectional drawing of several embodiments of piezoelectric transducer elements for generating and receiving longitudinal guided waves in the waveguide and tube.

FIG. 7 is a cross-sectional drawing of one embodiment of a piezoelectric transducer element for generating and receiving torsional guided waves in the waveguide and tube.

FIG. 8A is a drawing of two half cylinders of piezoelectric material poled circumferentially.

FIG. 8B is a drawing of a circumferentially-poled piezoelectric shear ring transducer element connected to an AC voltage source.

FIG. 8C is a conceptual illustration of the torsional vibration of a circumferentially-poled piezoelectric shear ring transducer element.

FIG. 9 is a conceptual illustration of one embodiment of the invention featuring interchangeable piezoelectric and magnetostrictive transducer elements.

FIG. 10A is a guided wave signal in a waveguide with no additional damping mechanisms.

FIG. 10B is a guided wave signal in a waveguide with several damping mechanisms.

FIG. 11 is a conceptual illustration of one embodiment of the invention featuring several waveguide damping mechanisms to reduce reverberations.

FIG. 12 is a drawing of one embodiment of the invention in which at least one end of the waveguide is profiled to scatter the ultrasonic energy and reduce reverberations.

FIG. 13A is a drawing of one embodiment of the invention in which the waveguide-tube interaction zone is tapered to a larger diameter than the remainder of the waveguide.

FIG. 13B is a drawing of one embodiment of the invention in which the waveguide-tube interaction zone is tailored to a larger diameter than the remainder of the waveguide over several equally-spaced regions.

FIG. 14A is a fast frequency analysis (FFA) plot showing reflections from several defects, the tube end, and reverberations in the waveguide, as well as the dispersion of the longitudinal mode in the tube.

FIG. 14B is a composite signal comparison between compensated and uncompensated waveforms collected in a tube using the invention.

FIG. 15 is a schematic of the invention.

### DETAILED DESCRIPTION

This description of the exemplary embodiments is non-limiting and is intended to be read in connection with the accompanying drawings, which are to be considered part of the entire written description.

In some embodiments, a system and method for the non-destructive inspection of tubing using ultrasonic guided waves is disclosed. The guided waves are generated and received by at least one magnetostrictive or piezoelectric transducer attached to a hollow cylindrical fitted waveguide that is inserted into the bore of a tube. The fitted hollow waveguide cylinder is designed to fit with minimal clearance between its outer diameter and the inner diameter of the tube, and guided wave coupling is achieved by the use of a shear couplant layer between the waveguide and the tube. A guided wave is generated in the waveguide by the transducer and subsequently propagates along the waveguide toward the waveguide-tube interaction region, where a portion of the guided wave energy is transmitted into the tube in the form of a guided wave. The invention utilizes standard pulse-echo or pitch-catch inspection techniques in which the generated wave, upon encountering an anomaly in the tube, will be partially reflected back to the transducer which then acts as a receiver to detect the anomaly. Using the known group velocity of the guided waves in the tube, the axial location of the anomaly can be determined.

In some embodiments, the lack of an expansion mechanism for coupling the waveguide cylinder to the tube allows the cross-section of the waveguide cylinder to remain constant along its entire length between the ultrasonic transducer and the section of the waveguide that is coupled to the tube. Previous systems utilize various expansions mechanisms in the waveguide-tube interaction region; however, these require splitting of the waveguide walls or other changes in cross-sectional shape. The changes in cross-section cause mode conversion and guided wave energy reflection at the expander as the incident wave propagates from the transducer to the tube and again as the guided wave reflections from anomalies in the tube propagate back through the expansion mechanism toward the transducer. The expansion mechanism of prior systems inherently reduces the signal-to-noise ratio of the ultrasonic tube inspection.

In some embodiments, the system may be used to inspect twisted tubing and in other embodiments it may be used to inspect straight (i.e. non-twisted) tubing, either of which may contain bends.

In some embodiments, the system comprises a waveguide tube, a shear couplant, at least one ultrasonic transducer, at least one handle attached to the waveguide, a signal generator/receiver, a processor, and a machine-readable storage medium, and a user interface.

In some embodiments, the invention utilizes interchangeable transducers that can be connected to one of a series of fitted waveguides to accommodate a range of tube sizes. The transducer comprises at least one of a magnetostrictive transducer capable of generating and receiving longitudinal waves, a piezoelectric transducer capable of generating and receiving longitudinal waves, and a piezoelectric transducer generating and receiving torsional waves.

In some embodiments, at least two transducer elements are utilized to achieve directional wave control in the waveguide.

In some embodiments, damping mechanisms, including but not limited to attenuative material on at least one end of the waveguide, attenuative material on portions of the inner and outer diameters of the waveguide, and profiling of at least one end of the waveguide, are utilized to reduce the ringing of the incident ultrasonic guided wave pulse in the waveguide.

In some embodiments, a couplant delivery system is utilized to inject shear couplant into the waveguide-tube interface.

In some embodiments, a resistive heating element is utilized in the waveguide to control the viscosity of shear couplant at the waveguide-tube interface.

In some embodiments, tapering and contouring of the waveguide is used in the waveguide-defect interaction region to control the geometry of the region in order to at least one of control guided wave mode and frequency, control the length of the coupled region, and maximize the transfer of guided wave energy between the waveguide and the tube.

In some embodiments, collet grips, pin fixtures, set screws, or similar mechanisms are utilized to attach at least one handle to the waveguide tube assembly.

In some embodiments, guided wave data is collected across a range of frequencies between 20 kHz and 2 MHz to improve defect sensitivity and inspection reliability. In additional embodiments, guided wave phase velocity and group velocity dispersion curves are utilized to compensate for the dispersive nature of longitudinal modes in the tube.

In one preferred, non-limiting embodiment of the invention, the operator would select, from a series of available waveguide tubes, the waveguide tube that provides the closest fit to the inner diameter of the tubes to be inspected. The operator would attach the interchangeable threaded piezoelectric transducer element to the end of the selected tube, apply shear couplant to the interaction region, insert the probe into the tube and perform the inspection. The inspection would comprise generating a series of ultrasonic pulses over a pre-determined frequency range, recording any reflected echoes, and post-processing those echoes to generate a fast frequency analysis plot and a composite dispersion-compensated signal to identify anomalies.

In another preferred, non-limiting embodiment of the invention, the operator would select, from a series of available waveguide tubes, the waveguide tube that provides the closest fit to the inner diameter of the tubes to be inspected. Each waveguide tube in the series would already be outfitted with a magnetostrictive transducer. The operator would then apply shear couplant to the interaction region, insert the probe into the tube and perform the inspection. The inspection would comprise generating a series of ultrasonic pulses over a pre-determined frequency range, recording any reflected echoes, and post-processing those echoes to generate a fast frequency analysis plot and a composite dispersion-compensated signal to identify anomalies.

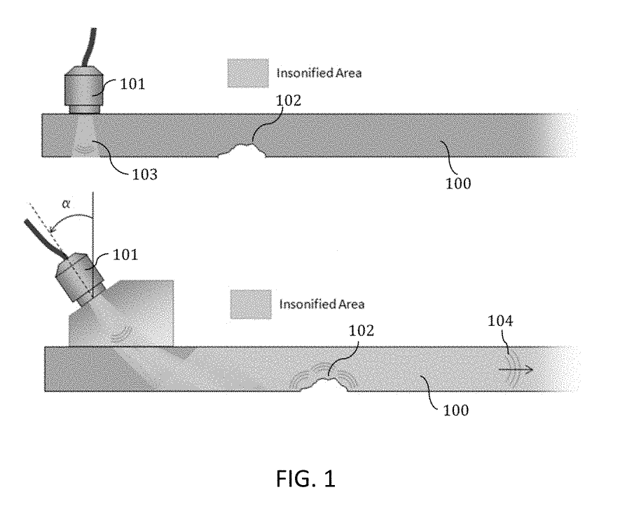

Guided waves 104 are formed from the constructive interference of ultrasonic bulk waves 103 that have interacted with the boundaries of the structure 100 in which they propagate. In the embodiment illustrated in FIG. 1, an ultrasonic transducer 101 is used to generate either bulk waves 103 or guided waves 104 to detect a corrosion defect 102. Guided waves are unique in the sense that they are capable of propagating for long distances compared to traditional ultrasonic waves and can be used to inspect hidden/inaccessible structures like buried or cased piping and tubing. Unlike “spot-checking” with traditional ultrasonic techniques, in some embodiments, guided waves provide a 100% volumetric inspection. Furthermore, guided waves provide an efficient and cost-effective means of inspection due to increased inspection speed and simplicity.

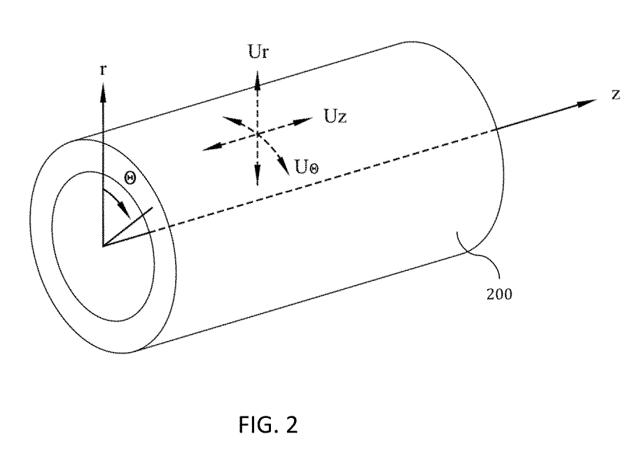

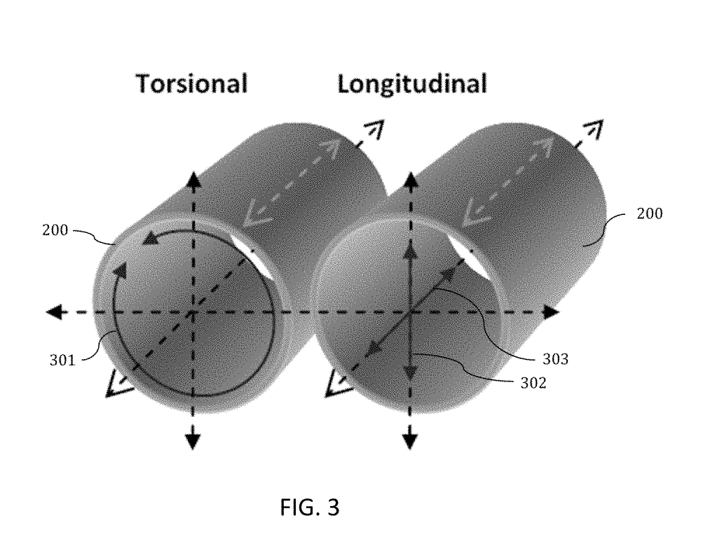

In piping and tubing, there are two primary guided wave mode types that can be excited: torsional and longitudinal. The general coordinate system for describing guided waves in hollow cylinders is illustrated in FIG. 2. Referring to FIG. 3, torsional modes in pipes or tubes 200 induce primarily circumferential displacements 301 in the U® direction, and longitudinal modes induce primarily radial displacements 302 and axial displacements 303 in the Uᵣ and U_{z} directions, respectively.

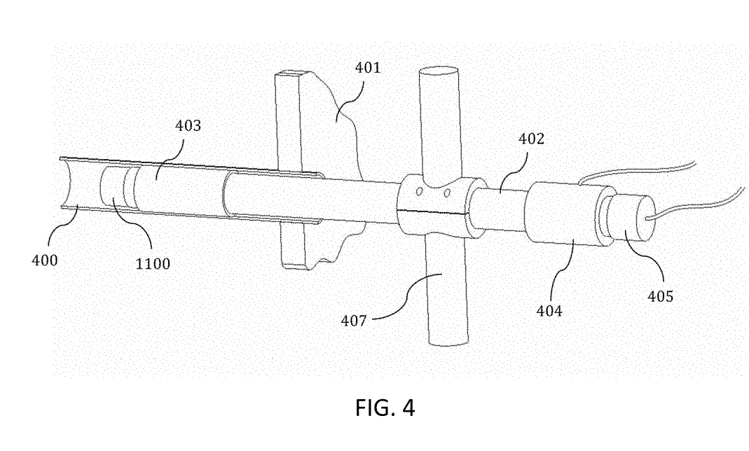

In some embodiments, as illustrated in FIG. 4, is a system and method for the non-destructive inspection of tubing using ultrasonic guided waves, is disclosed. The guided waves are generated and received by at least one of a magnetostrictive transducer 404 and/or a piezoelectric transducer 405 attached to a hollow cylindrical fitted waveguide 402 that is inserted into the bore of a tube 400 beyond a tube sheet 401. In some embodiments, the fitted hollow waveguide cylinder 402 features a region 403 with a slightly larger diameter to fit with minimal clearance between an outer diameter of the hollow waveguide 402 and the inner diameter of the tube 400. Guided wave coupling between the waveguide 402 and tube 400 at the interface region 403 can be achieved by the use of a shear couplant layer between the waveguide 402 and the tube 400. In some embodiments, a damping mechanisms 406 is configured to reduce reverberations in the waveguide 402. The waveguide 402 can further include handles 407 to aid the operator in inserting and extracting the waveguide 402 from the tube 400.

In some embodiments, the system includes at least one of a magnetostrictive transducer capable of generating and receiving longitudinal waves, a piezoelectric transducer capable of generating and receiving longitudinal waves, and a piezoelectric transducer generating and receiving torsional waves.

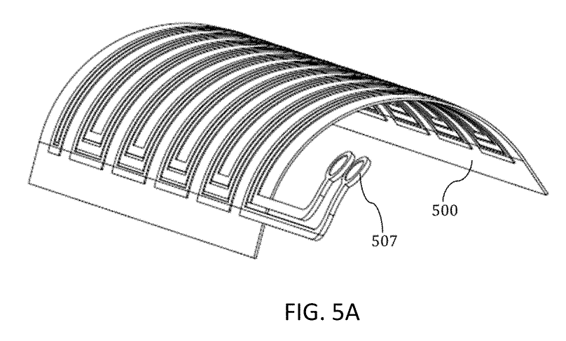

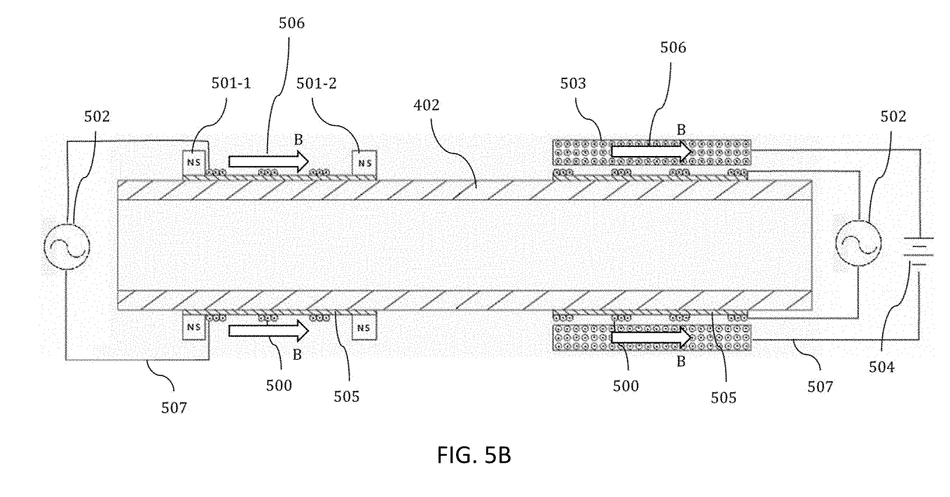

In embodiments in which at least one magnetostrictive transducer is utilized to at least one of generate and receive longitudinal modes, the at least one element comprises at least one strip of ferromagnetic material 505 bonded to the waveguide 402, at least one sensor coil 500, leads 507 to connect the pulser coil to a time-varying current source 502, and a magnetic inducer configured to induce a biasing magnetic field 506 parallel to the axis of the waveguide 402. The at least one sensor coil 500 can include a ribbon cable, a flexible printed circuit board 500, and/or any other suitable sensor coil, as illustrated in FIG. 5A.

The magnetic inducer can include, but is not limited to, at least one permanent magnet 501 or an electromagnet comprised of a circumferentially wound coil 503 connected to a high-voltage DC or pulsed source 504, as illustrated in FIG. 5B.

In some embodiments, piezoceramic elements having a d₃₃ configuration are generally some variation of sintered lead zirconate titanate that has been cured and then poled and electroded along a common axis. Piezocomposite elements having a 1-3 configuration are generally comprised of an arrangement of d₃₃ piezoelectric rods or cylinders embedded in a gas or solid matrix.

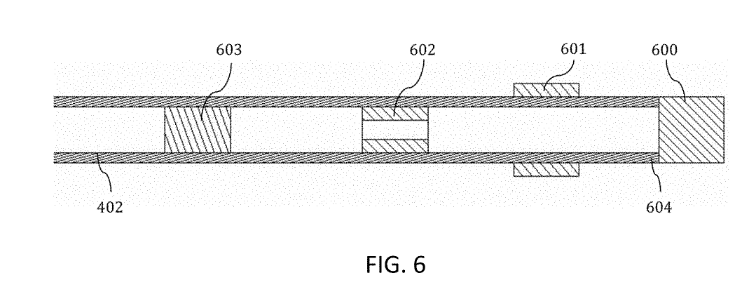

Referring to FIG. 6, in some embodiments, at least one piezoelectric transducer is utilized to at least one of generate and/or receive longitudinal modes. The at least one piezoelectric transducer can include a d₃₃ piezoelectric element 600 or a 1-3 piezocomposite element 600 coupled to the end 604 of the waveguide 402 farthest from the tube 400. In another embodiment, the transducer can include at least one annular d₃₃ piezoelectric element 601 or 1-3 piezocomposite element 601 coupled to the outer diameter of the waveguide 402. In yet another embodiment, the transducer can include at least one cylindrical 603 or annular 602 d₃₃ piezoelectric element or 1-3 piezocomposite element coupled to the inner diameter of the waveguide 402. Although specific embodiments are discussed herein, it will be appreciated that elements of the disclosed embodiments can be combined and/or omitted.

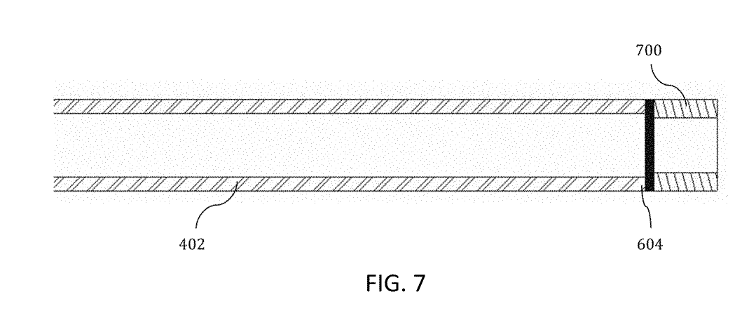

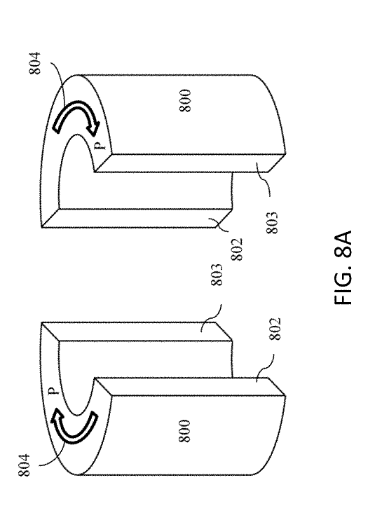

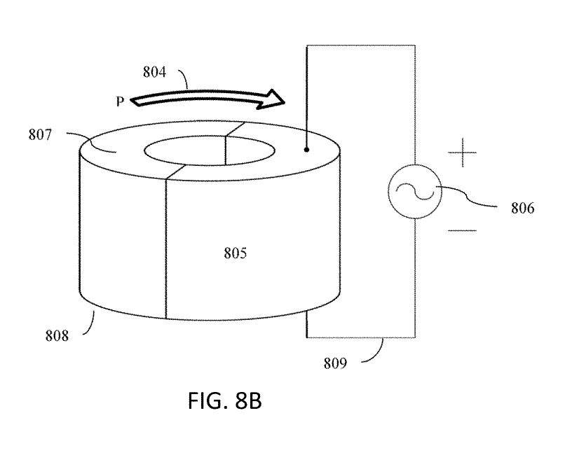

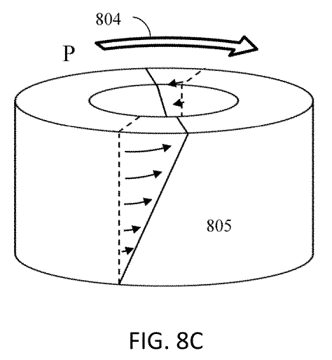

Referring to FIG. 7, in some embodiments, at least one piezoelectric transducer is utilized to at least one of generate and receive torsional modes. The at least one piezoelectric transducer can include a shear ring element 700 coupled to the end 604 of the waveguide 402 farthest from the tube 400. In some embodiments, the shear ring element is fabricated from two half rings 800, as illustrated in FIG. 8A, that are polarized quasi-circumferentially, in accordance with arrows 804, by applying high-voltage DC poling electrodes to the two vertical faces 802 and 803 while the temperature of the element exceeds the Curie temperature for the piezoceramic. The half rings 800 are subsequently bonded together to form a full ring element 805 as illustrated in FIG. 8B, which can be excited with voltage source 806 applied to the upper and lower electrode surfaces 807 and 808 via leads 809. A torsional vibration mode of the shear ring element 805 is illustrated in FIG. 8C. In some embodiments of the shear ring element, more than two cylindrical sections may be used. In additional configurations, the sections may only approximate a circular cylindrical shape.

In some embodiments, at least two transducer elements are utilized to control the direction of the guided waves in the waveguide 402 by applying time delays to the at least two transducer elements to cancel a reverse-propagating wave. In some embodiments, the at least two transducer elements are utilized to control the mode and frequency of the guided wave mode generated in the waveguide 402 by either spacing the elements with a center-to-center separation equal to the wavelength of the desired guided wave mode and frequency in the waveguide 402 and/or by applying at least one of time delays and/or amplitude factors to the elements.

In some embodiments, the at least one transducer element is permanently bonded to the waveguide 402. In some embodiments, the at least one transducer element is interchangeable between various waveguides 402.

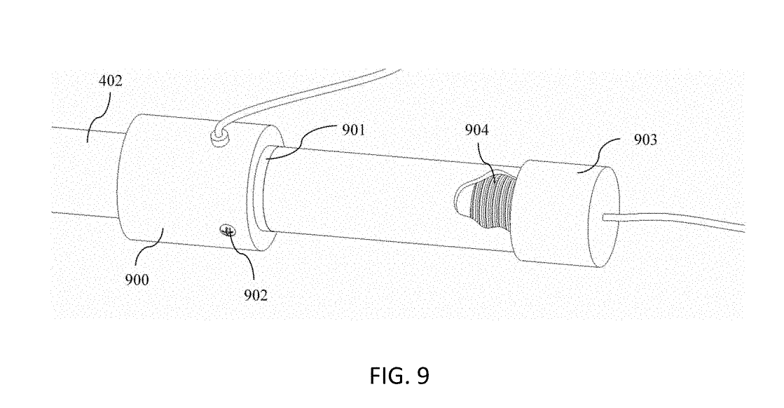

FIG. 9 shows non-limiting embodiments of interchangeable transducer elements. One non-limiting embodiment of an interchangeable magnetostrictive element 900 includes a hollow cylindrical housing with an inner diameter slightly larger than the outer diameter of the waveguide 402, a sensor coil, and one of at least one permanent magnet and/or an electromagnet coil. The interchangeable magnetostrictive element is configured to be slipped over one end of the waveguide 402 and fastened in place via a set screw 902 over a permanently bonded ferromagnetic strip 901. Additionally, one non-limiting embodiment of an interchangeable piezoelectric element 903 is configured to be connected to the end of the waveguide 402 farthest from the tube 400 via threads 904 on the inner and/or outer diameter of the waveguide 402.

In some embodiments, a pulse-echo inspection methodology is applied, in which at least one transducer element generates the incident guided wave pulse and the at least one transducer element also detects the guided wave reflections from anomalies in the tube. In alternative embodiments, a pitch-catch inspection methodology is applied, in which at least one transducer element generates the incident guided wave pulse and at least one other transducer element detects the guided wave reflections from anomalies in the tube in order to reduce the inspection “dead zone” and minimize electronic noise. In some embodiments in which the pitch-catch methodology is adopted, at least one of the elements is a magnetostrictive coil and at least one of the elements is a piezoelectric transducer.

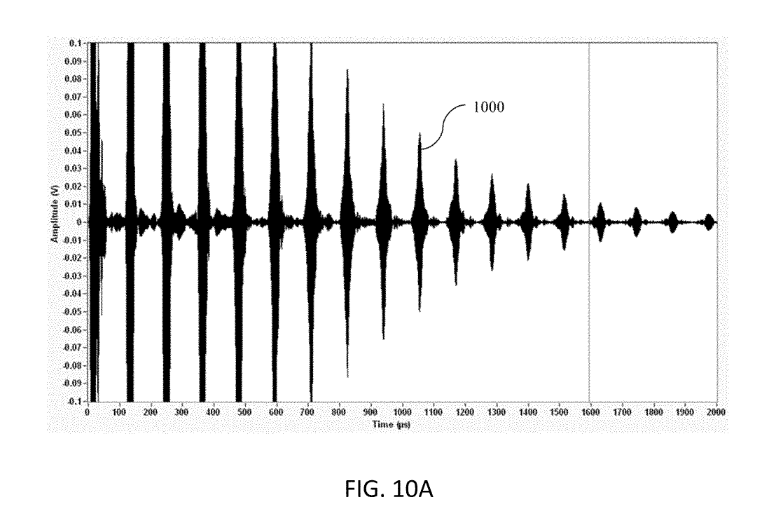

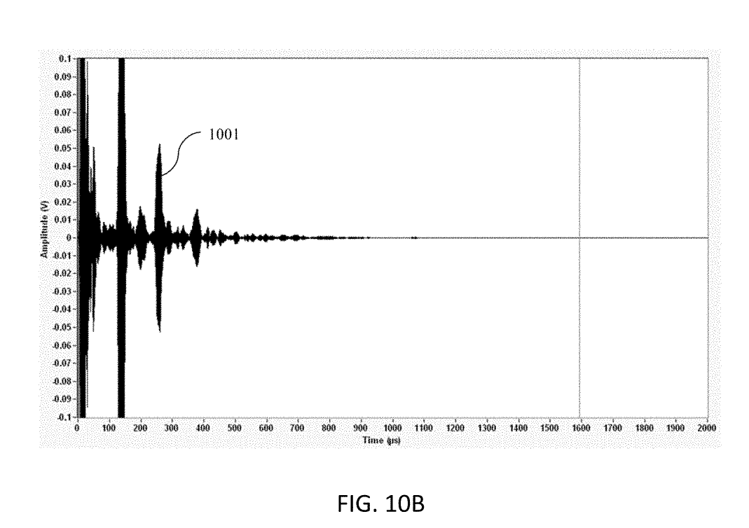

In some embodiments, a portion of the guided wave energy generated in the waveguide by the at least one transducer element will not be transmitted into the tube across the waveguide-tube interface. The energy can continue to propagate in the waveguide and will reverberate between the two ends. Referring to FIG. 10A, in some embodiments, these reverberations 1000 will be detected by the at least one transducer element and may increase the dead zone of the inspection and/or cause confusion for the system operator during interpretation of the inspection data. In some embodiments, one or more features are included to attenuate and/or minimize reverberations 1001, as shown in FIG. 10B and as discussed below.

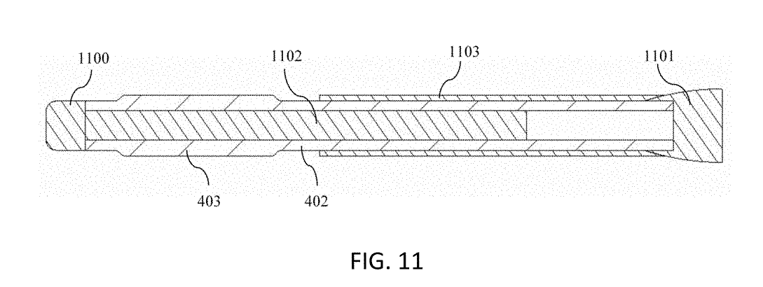

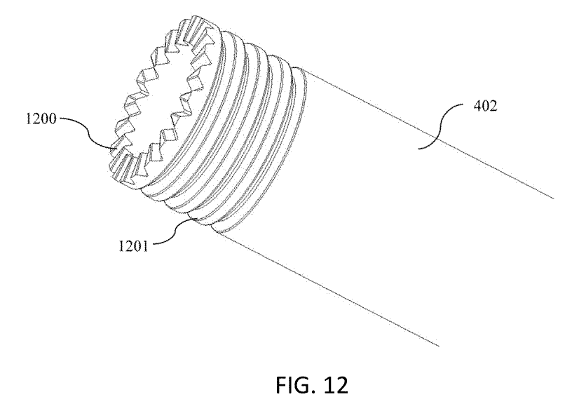

In some embodiments, as illustrated in FIG. 11, reverberations are minimized by at least one of attenuative material 1100 coupled to the end of the waveguide 402 nearest the tube 400, attenuative material 1101 coupled to the end of the waveguide farthest from the tube, attenuative material 1102 coupled to the inner diameter of the waveguide, and attenuative material 1103 coupled to the outer diameter of the waveguide. The attenuative material may include, but is not limited to, rubber, composite, epoxy, and doped epoxy compounds. In additional embodiments, such as one illustrated in FIG. 12, at least one end of the waveguide 402 is profiled on at least one of the axial face 1200 and the radial face 1201 to scatter the energy reflected from the ends and to thereby reduce the reverberations.

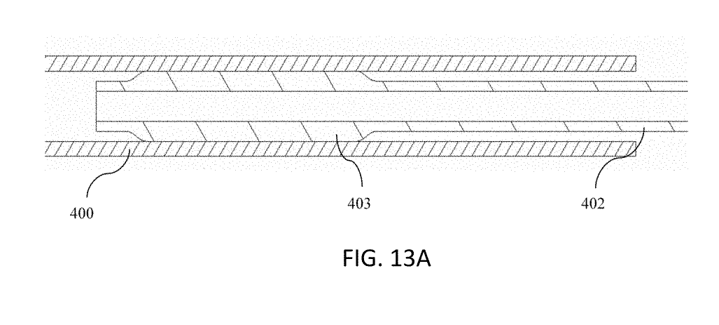

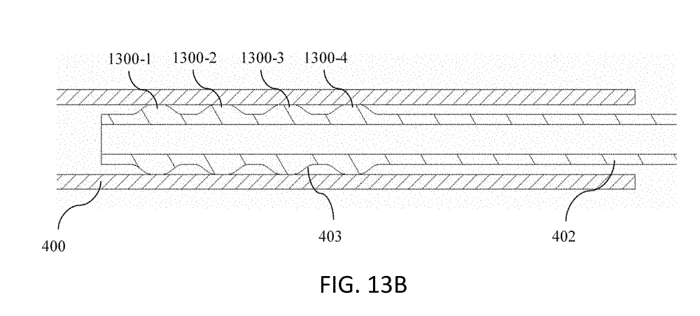

Referring to FIG. 13A, in some embodiments, the waveguide-defect interaction region 403 can be tailored to control the transmission of guided wave energy from the waveguide 402 into the tube 400 and vice versa. In some embodiments, the length of the region 403 is controlled by tapering the waveguide 402 to a greater diameter than the remainder of the waveguide 403 in the region over a defined length. The tapering influences the transmission coefficient of the guided wave energy from the waveguide 402 to the tube 400 and vice versa. In additional embodiments, referring to FIG. 13B, a series of equally-spaced sections 1300 within the region have a greater diameter than the remainder of the waveguide 402. The center-to-center spacing and the width of the equally-spaced sections 1300 can be tailored to match the wavelength of a particular guided wave mode and frequency in at least one of the waveguide 402 and the tube 400. This concept is similar to that of a comb transducer for guided wave generation and detection in plates and pipes.

In some embodiments, a couplant delivery system comprised of at least one small hole or slot in the waveguide-tube interaction region, a reservoir of shear couplant, and a pumping mechanism is utilized to inject shear couplant into the waveguide-tube interface.

In some embodiments, a resistive heating element in the waveguide is utilized to control the viscosity of shear couplant at the waveguide-tube interface by heating the waveguide.

In some embodiments, collet grips, pin fixtures, set screws, or similar mechanisms are utilized to attach at least one handle to the waveguide tube assembly. In an alternative embodiment, the end of the waveguide farthest from the tube is flared to act as a handle.

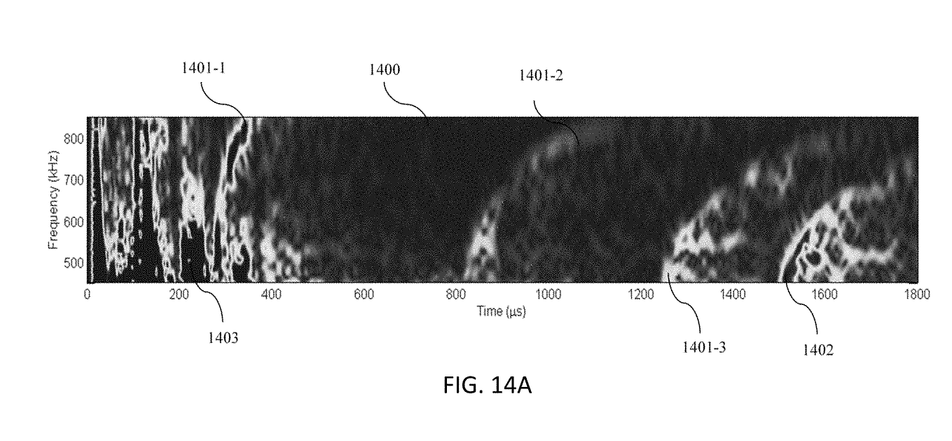

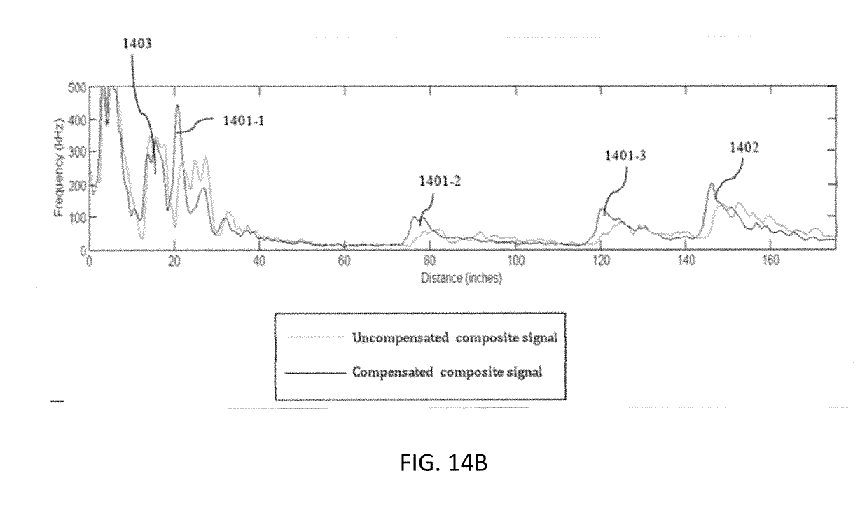

In some embodiments, guided wave data is collected across a range of frequencies between 20 kHz and 2 MHz to improve defect sensitivity and inspection reliability and generate a fast frequency analysis (FFA) plot 1400, as illustrated in FIG. 14A. The FFA plot 1400 includes several defect reflections 1401, a tube sheet reflection 1402, and waveguide reverberations 1403.

In additional embodiments, guided wave phase velocity and group velocity dispersion curves are utilized to compensate for the dispersive nature of longitudinal modes in the tube 400 when generating and displaying the FFA plot 1400 or a composite signal that combines the data across a range of frequencies, as illustrated in FIG. 14B. The compensation may be achieved by a time-domain delay and shift algorithm and/or by a frequency-domain back-propagation algorithm, in which the time-domain signals are converted into the frequency domain and then into the wavenumber domain by applying the known phase and group-velocity dispersion curve values for each frequency component, and are then converted into the distance domain.

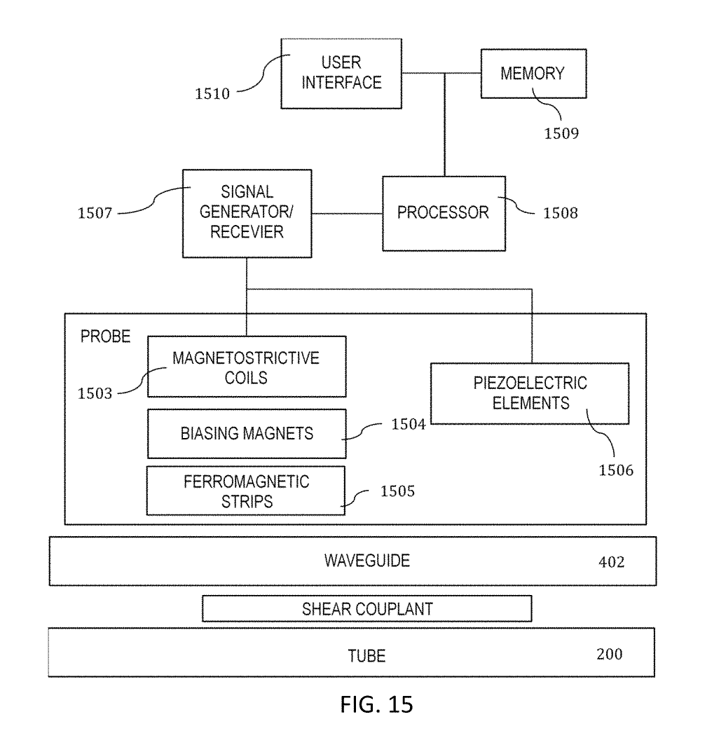

Referring to the schematic in FIG. 15, in some embodiments, the system includes at least one ultrasonic signal generator/receiver 1507, which includes at least an ultrasonic tone-burst pulser, an analog-to-digital converter, and a pre-amplifier, a user interface 1510, a machine readable storage medium 1509, and a processor 1508 in signal communication with the machine readable storage medium 1509. The processor 1508 and signal generator/receiver 1507 are configured to generate at least one pulse from the at least one of a magnetostrictive transducer element 1503 and a piezoelectric element 1506, process the reflected signals detected by the at least one transducer element 1503, convert time-domain data into a distance domain, and record the waveform information in a machine readable storage medium.

What is claimed is:

1. A system for the non-destructive inspection of a structure, comprising:
a probe comprising a hollow cylindrical waveguide having a first region and a second region, wherein the first region has a first diameter and the second region has a second diameter, wherein the second diameter is greater than the first diameter, and wherein first diameter is sized and configured for insertion into a structure; and
at least one of sensor element capable of generating and detecting longitudinal and/or torsional ultrasonic guided waves in the waveguide, wherein the at least one sensor element is configured to generate a guided wave pulse in the waveguide when at least one of a time-varying current or a time-varying voltage is provided to the at least one sensor element, wherein the at least one sensor element is configured to detect reflected guided wave energy from one or more anomalies in the tube.

2. The system of claim 1, wherein the at least one sensor element is a magnetostrictive sensor element, the magnetostrictive sensor element further comprising:
a ferromagnetic strip coupled to the waveguide;
a current-carrying sensor coil, and wherein a biasing magnetic field is applied within the ferromagnetic strip, and wherein the biasing magnetic field is aligned either parallel to or perpendicular to a central axis of the waveguide.

3. The system of claim 2, wherein the current-carrying sensor coil is a ribbon cable.

4. The system of claim 2, wherein the current-carrying sensor coil is a flexible printed circuit board.

5. The system of claim 2, wherein the biasing magnetic field is generated by at least one permanent magnet or by an electromagnet coil and a current source.

6. The system of claim 1, wherein the at least one sensor element is a piezoelectric sensor element, wherein the piezoelectric sensor element comprises at least one of:
a piezoelectric cylinder coupled to a first end of the waveguide;
a piezoelectric ring coupled to first end of the waveguide;
a piezoelectric cylinder coupled to an inner diameter of the waveguide;
a piezoelectric ring coupled to the inner diameter of the waveguide; or
a piezoelectric ring coupled to an outer diameter of the waveguide.

7. The system of claim 6, wherein the piezoelectric sensor element comprises one of a 1-3 piezocomposite element or a d₃₃-polarized piezocomposite element.

8. The system of claim 1, wherein the least one sensor element comprises a shear ring element including at least two cylindrical sections individually poled in a quasi-circumferential manner, wherein the at least two cylindrical sections are bonded together in a d₁₅ configuration.

9. The system of claim 1, wherein the at least one sensor elements includes at least two sensor elements coupled to the waveguide and axially separated by a predetermined spacing configured to at least one of: preferentially excite a particular guided wave mode and frequency range in the waveguide; excite a particular guided wave mode and frequency range in the waveguide by means of at least one of a time delay or an amplitude factor applied between the at least two sensor elements; or suppress a reverse-traveling component of the guided waves generated in the waveguide by means of a time delay applied between the at least two sensor elements.

10. The system of claim 1, wherein the at least one sensor element is removable and interchangeable.

11. The system of claim 1, wherein an attenuative material is coupled to at least one of an inner diameter of the waveguide, an outer diameter of the waveguide, a first end of the waveguide, and a second end of the waveguide, wherein the attenuative material is configured to minimize guided wave reverberations from the incident pulse.

12. The system of claim 1, wherein profiling of a first end of the waveguide is utilized to scatter guided wave energy reflected from the first end to minimize guided wave reverberations from an incident pulse.

13. The system of claim 1, wherein the second region of the probe includes a length configured to transmit guided wave energy from the waveguide into the structure and from the structure into the waveguide.

14. The system of claim 1, wherein the second region further comprises at least two sub-regions each having a diameter equal to the second diameter and separated by at least one sub-region having a diameter less than the second diameter, and wherein a length and spacing of the sub-regions is configured to control a guided wave mode and frequency range that is efficiently transmitted from the waveguide into the structure and from the structure into the waveguide.

15. The system of claim 1, further comprising a couplant delivery system comprising a reservoir of shear couplant, a pumping mechanism, and at least one of a hole or a slit in the second region through which the couplant is injected.

16. The system of claim 15, further comprising a resistive heating element configured to control a temperature of the waveguide and shear couplant.

17. The system of claim 1, further comprising at least one handle attached to the waveguide configured for inserting and removing the probe.

18. A method comprising:
generating guided waves in a structure, wherein the guided waves are generated by at least one sensor element in a waveguide having a first region and a second region, wherein the first region has a first diameter and the second region has a second diameter, wherein the second diameter is greater than the first diameter, and wherein first diameter is sized and configured for insertion into a structure,
detecting reflected guided wave energy from anomalies in the structure;
wherein the reflected guided wave energy is detected by the at least one sensor element.

19. The method of claim 18, wherein the guided waves are generated by applying at least one of a time-varying current or a time-varying voltage to the at least one sensor element, wherein the at least one time-varying current or time-varying voltage is generated by an electronic tone-burst pulser system having at least one pulser channel.

20. The method of claim 18, wherein the reflected guided wave energy is detected by amplifying the detected signal with a pre-amplifier, processing the amplified detected signal with an analog-to-digital converter, and recording the amplified detecte signal with a processor.

21. The method of claim 18, wherein guided wave data is collected for at least two central pulse frequencies and is subsequently combined to generate a two-dimensional frequency versus distance plot of the reflected guided wave signals.

22. The method of claim 18, wherein a guided wave mode generated in the waveguide is of a longitudinal type and at least one of a time-domain stretch-and-shift algorithm or a frequency-domain back-propagation algorithm is utilized to compensate for dispersion of the guided waves in the structure.
